(19) United States
(12) Patent Application Publication
(10) Pub. No.: US 2021/0333988 A1
(43) Pub. Date: Oct. 28, 2021

(54) METHOD AND DEVICE FOR SWITCHING INTERFACE, TOUCH TERMINAL, AND STORAGE MEDIUM

(71) Applicant: BEIJING DAJIA INTERNET INFORMATION TECHNOLOGY CO., LTD., Beijing (CN)

(72) Inventors: Yu Zhao, Beijing (CN); Qiang Xu, Beijing (CN)

(21) Appl. No.: 17/138,620

(22) Filed: Dec. 30, 2020

(30) Foreign Application Priority Data
Apr. 26, 2020 (CN) 202010338554.8

(51) Int. Cl. G06F 3/0488; H04N 5/232

(52) U.S. Cl. CPC G06F 3/04883; H04N 5/232933

(57) ABSTRACT

The disclosure relates to a method for switching an interface, which is applied to a touch terminal capable of presenting a graphical user interface. The method can include: displaying a shooting interface; receiving a sliding operation performed by a user on the shooting interface; and switching the shooting interface to an album interface in response to the sliding operation in response to determining that the sliding operation is a present sliding operation.

### CROSS-REFERENCE TO RELATED APPLICATIONS

This application is based upon and claims priority to Chinese Patent Application No. 202010338554.8, filed on Apr. 26, 2020, the disclosure of which is incorporated herein by reference in its entirety.

### TECHNICAL FIELD

The disclosure relates to the Internet field, and in particular to a method and device for switching an interface, a touch terminal, and a storage medium.

### BACKGROUND

With the rapid development of short video applications, more and more people publish and share multimedia content such as pictures, videos, and music through mobile terminals installed with the short video applications. There may be a low efficient when users want to publish and share something. For example, the operation for users to upload album works may include searching and clicking a portal to upload something and is cumbersome.

The above information is presented as background information only to assist with an understanding of the disclosure. No determination has been made, and no assertion is made, as to whether any of the above might by applicable as prior art with regard to the disclosure.

### SUMMARY

According to a first aspect of implementations of the disclosure, a method for switching an interface is provided, which is applied to a touch terminal capable of presenting a graphical user interface. The method includes displaying a shooting interface; receiving a sliding operation performed by a user on the shooting interface. The method includes switching the shooting interface to an album interface in response to that the sliding operation is a predetermined sliding operation.

According to a second aspect of implementations of the disclosure, a device for switching an interface is provided, which is applied to a touch terminal capable of presenting a graphical user interface. The device includes a display unit configured to display a shooting interface. The device includes a receiving unit configured to receive a sliding operation performed by a user on the shooting interface. The device includes a switching unit configured to switch the shooting interface to an album interface in response to that the sliding operation is a predetermined sliding operation.

According to a third aspect of implementations of the disclosure, there is provided a touch terminal, including a memory and a processor, the memory stores a computer program, and the processor performs the method for switching the interface according to the first aspect or any of possible implementations of the first aspect when executing the computer program.

According to a fourth aspect of implementations of the disclosure, there is provided a storage medium having stored thereon a computer program which, when being executed by a processor, implements the method for switching the interface according to the first aspect or any of possible implementations of the first aspect.

According to a fifth aspect of implementations of the disclosure, there is provided a computer program product including a computer program which is stored in a readable storage medium, and at least one processor of a device reads from the readable storage medium and executes the computer program to cause the device to perform the method for switching the interface according to any of implementations of the first aspect.

It should be understood that the above general description and the following detailed description are only example and explanatory, and do not limit the disclosure.

### BRIEF DESCRIPTION OF THE DRAWINGS

The drawings herein are incorporated into and constitute a part of the specification, show implementations conforming to the disclosure, together with the specification serve to explain the principles of the disclosure, and do not constitute an improper limitation of the disclosure.

FIG. 1 is a diagram of an application environment of a method for switching an interface according to an example implementation.

FIG. 2 is a flowchart showing a method for switching an interface according to an example implementation.

FIG. 3 is a schematic diagram showing a shooting interface of a short video application according to an example implementation.

FIG. 4 is a schematic diagram showing an album interface of a short video application according to an example implementation.

FIG. 5 is a flowchart showing another method for switching an interface according to an example implementation.

FIG. 6 is a schematic diagram showing an upward sliding operation according to an example implementation.

FIG. 7 is a schematic diagram showing an interface switching process according to an example implementation.

FIG. 8 is a flowchart showing a method for switching an interface according to another example implementation.

FIG. 9 is a block diagram showing a device for switching an interface according to an example implementation.

FIG. 10 is a diagram showing an internal structure of a touch terminal according to an example implementation.

### DETAILED DESCRIPTION

In order to enable those of ordinary skill in the art to better understand the technical solutions of the disclosure, the technical solutions in the implementations of the disclosure will be described clearly and completely below with reference to the accompanying drawings.

It should be noted that the terms of “first”, “second”, etc. in the specification and claims of the disclosure and the above-mentioned drawings are used to distinguish similar objects, and are not necessarily used to describe a specific sequence or order. It should be understood that the terms used in this way can be interchanged under appropriate circumstances so that the implementations of the disclosure described herein can be implemented in orders other than those illustrated or described herein. The implementations described in the following example implementations do not represent all implementations consistent with the disclosure. Rather, they are only examples of devices and methods consistent with some aspects of the disclosure as detailed in the appended claims.

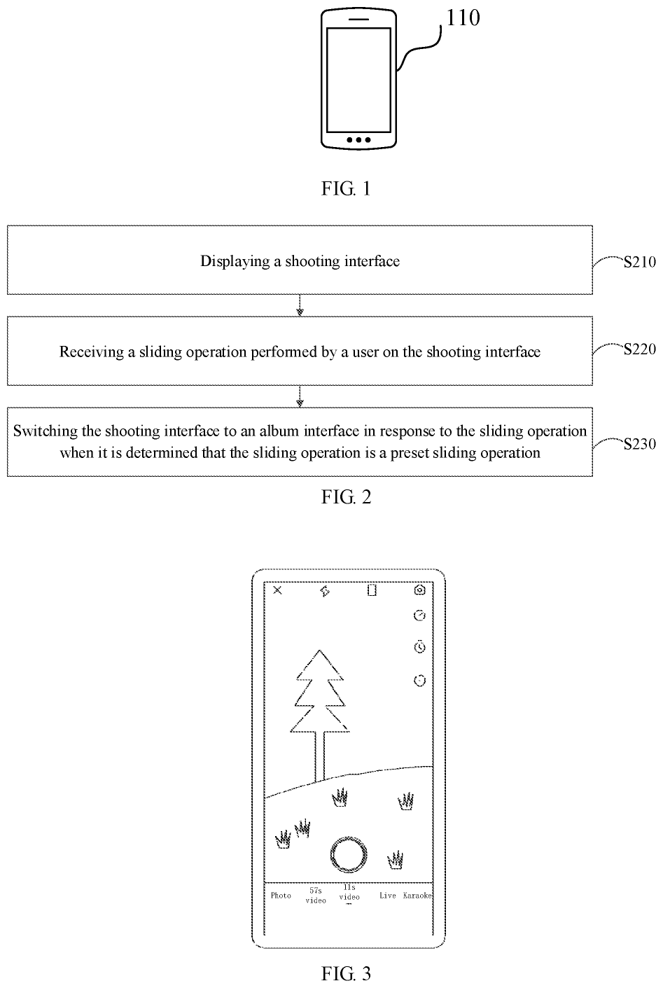

A method for switching an interface provided by the disclosure can be applied to an application environment as shown in FIG. 1. A touch terminal 110 displays a shooting interface, receives a sliding operation performed by a user on the shooting interface, and switches the shooting interface to an album interface in response to the sliding operation when the touch terminal 110 determines that the sliding operation is a predetermined sliding operation. The touch terminal 110 may be, but is not limited to, various personal computers, notebook computers, smart phones, tablet computers, and portable wearable devices.

FIG. 2 is a flow chart showing a method for switching an interface according to an example implementation. As shown in FIG. 2, the method for switching the interface is applied to a touch terminal 110 capable of presenting a graphical user interface, and includes the following operations.

In S210, displaying a shooting interface.

The touch terminal 110 can display the shooting interface. The shooting interface may refer to a graphical user interface for the user to perform shooting.

In some implementations, when the user publishes a short video work by using the touch terminal 110 installed with a short video application, the user can click on a work publishing portal in the short video application to control the touch terminal 110 to start a camera application and display the shooting interface.

To facilitate understanding by those skilled in the art, FIG. 3 provides a schematic diagram of a shooting interface of a short video application.

In S220, receiving a sliding operation performed by a user on the shooting interface.

The touch terminal 110 can receive the sliding operation. The sliding operation may include, but is not limited to, an upward sliding operation, a downward sliding operation, a sliding-to-left operation, a sliding-to-right operation, and the like.

In some implementations, the touch terminal 110 receives the sliding operation performed by the user on the shooting interface.

In S230, switching the shooting interface to an album interface in response to the sliding operation when it is determined that the sliding operation is a predetermined sliding operation.

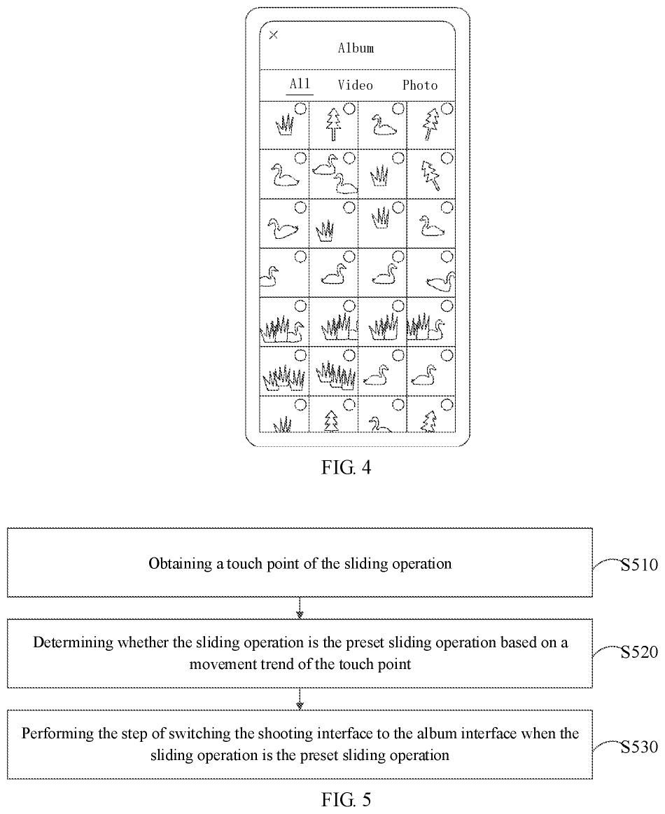

The touch terminal 110 can switch the shooting interface to the album interface in response to the sliding operation when it is determined that the sliding operation is the predetermined sliding operation. The album interface may refer to a graphical user interface used for the user to browse and check electronic album images. To facilitate understanding by those skilled in the art, FIG. 4 provides a schematic diagram of an album interface of a short video application.

In some implementations, when the touch terminal 110 receives the sliding operation performed by the user on the shooting interface, the touch terminal 110 determines whether the sliding operation matches the predetermined sliding operation. If the sliding operation performed by the user on the shooting interface matches the predetermined sliding operation, the touch terminal 110 switches the shooting interface to the album interface. In practical applications, in the process of switching the shooting interface to the album interface by the touch terminal 110, a moving direction of an animation for switching between the shooting interface and the album interface may be the same as a sliding direction of the sliding operation performed by the user on the shooting interface. Of course, a moving speed of the animation for switching between the shooting interface and the album interface may also be consistent with a sliding speed of the sliding operation performed by the user on the shooting interface.

In the above method for switching the interface, the shooting interface is displayed, and the shooting interface is switched to the album interface in response to the sliding operation when the sliding operation performed by the user on the shooting interface is received. As such, the user does not need to specially search for and click on the portal corresponding to the album interface in the shooting interface to start the album interface, which can optimize the experience of calling out the album and improving the efficiency of displaying the album interface by the touch terminal.

In some implementations, as shown in FIG. 5, in S230, the switching the shooting interface to the album interface in response to the sliding operation when it is determined that the sliding operation is the predetermined sliding operation can be specifically implemented by the following operations. In S510, obtaining a touch point of the sliding operation. The touch terminal 110 can obtain the touch point of the sliding operation. In S520, it is determined whether the sliding operation is the predetermined sliding operation based on a movement trend of the touch point. The touch terminal 110 can determine whether the sliding operation is the predetermined sliding operation based on the movement trend of the touch point. In S530, switching the shooting interface to the album interface in response to that the sliding operation is the predetermined sliding operation. The touch terminal 110 can switch the shooting interface to the album interface in response to that the sliding operation is the predetermined sliding operation.

The touch point may refer to a point where the user's finger touches in the graphical user interface.

In some implementations, the process of switching the shooting interface to the album interface in response to the sliding operation when the touch terminal 110 determines that the sliding operation is the predetermined sliding operation specifically includes: obtaining, by the touch terminal 110, the touch point of the sliding operation, and determining, by the touch terminal 110, whether the sliding operation is the predetermined sliding operation based on the movement trend of the touch point.

In practical applications, the predetermined sliding operation may be an upward sliding operation.

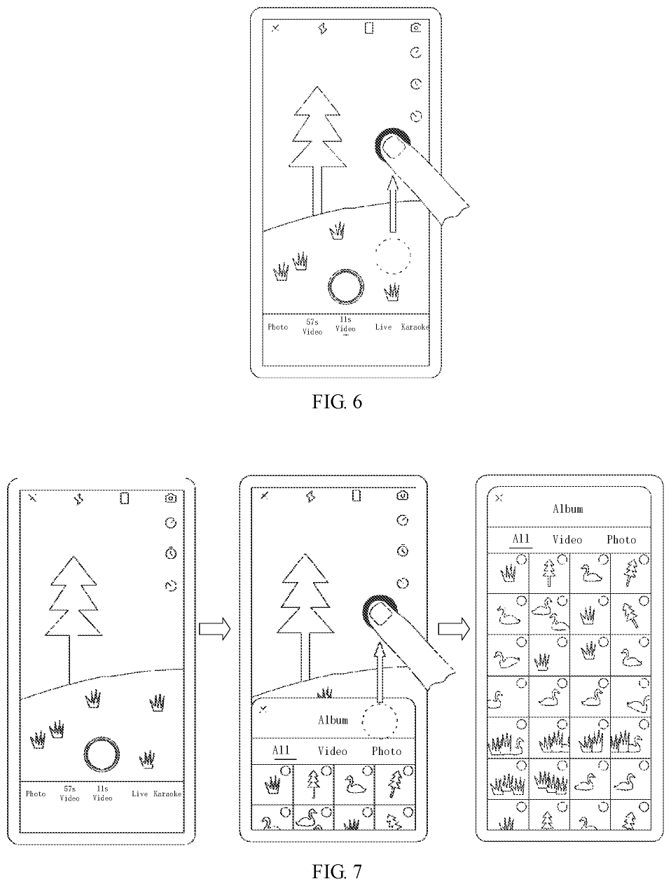

The upward sliding operation may refer to an operation in which the user's finger slides upward on the touch terminal. To facilitate the understanding by those skilled in the art, FIG. 6 provides a schematic diagram of an upward sliding operation.

In some implementations, when the predetermined sliding operation is the upward sliding operation, the touch terminal 110 may determine whether the movement trend of the touch point of the sliding operation is a movement from a bottom of the graphical user interface to a top of the graphical user interface, and if so, the touch terminal 110 determines that the sliding operation is the upward sliding operation, and switches the shooting interface to the album interface.

In order to facilitate the understanding by those skilled in the art, FIG. 7 provides a schematic diagram of an interface switching process.

In the technical solution of the implementation, the touch point of the sliding operation is obtained in real time, so as to accurately determine whether the sliding operation is the predetermined sliding operation based on the movement trend of the touch point.

In some implementations, determining whether the sliding operation is the predetermined sliding operation based on the movement trend of the touch point includes: obtaining a touch point movement distance of the touch point; determining a sliding start position and a sliding end position of the touch point in response to that the touch point movement distance is greater than a distance threshold; and determining that the sliding operation is the predetermined sliding operation based on a relative position between the sliding start position and the sliding end position.

The movement distance of the touch point may refer to a pixel distance that the touch point moves in the graphical user interface.

In some implementations, the process of determining, by the touch terminal 110, whether the sliding operation is the predetermined sliding operation based on the movement trend of the touch point specifically includes: obtaining, by the touch terminal 110, the touch point movement distance of the touch point; determining, by the touch terminal 110, whether the touch point movement distance is greater than a distance threshold, and triggering the touch terminal 110 to obtain the sliding start position and the sliding end position of the touch point when the touch terminal 110 determines that the touch point movement distance is greater than the distance threshold; and determining, by the touch terminal 110, the movement trend of the touch point based on the relative position between the sliding start position and the sliding end position to determine that the sliding operation is the predetermined sliding operation.

In practical applications, when the touch point movement distance is the pixel distance of the touch point moving in the graphical user interface, the distance threshold may be a distance of 50 pixels (px).

According to the technical solution of the implementation, in the process of determining whether the sliding operation is the predetermined sliding operation based on the movement trend of the touch point, the touch terminal determines whether the sliding operation is the predetermined sliding operation by determining the sliding start position and the sliding end position of the touch point only when the terminal determines that the touch point movement distance is greater than the distance threshold, so as to avoid switching to the album interface by triggering the predetermined sliding operation by the user by mistake.

In some implementations, when the predetermined sliding operation is the upward sliding operation, determining that the sliding operation is the predetermined sliding operation based on the relative position between the sliding start position and the sliding end position includes: obtaining a longitudinal movement value of the touch point by obtaining a difference between an ordinate of the sliding end position and an ordinate of the sliding start position; obtaining a lateral movement value of the touch point by obtaining a difference between an abscissa of the sliding end position and an abscissas of the sliding start position; and determining that the sliding operation is the upward sliding operation in response to that the longitudinal movement value of the touch point is greater than the lateral movement value of the touch point.

In some implementations, the process of determining, by the touch terminal 110, that the sliding operation is the upward sliding operation based on the relative position between the sliding start position and the sliding end position specifically includes: obtaining, by the touch terminal 110, an ordinate difference between the sliding start position and the sliding end position by subtracting the ordinate of the sliding start position from the ordinate of the sliding end position, as the longitudinal movement value of the touch point, and obtaining, by the touch terminal 110, an abscissa difference between the sliding start position and the sliding end position by subtracting the abscissa of the sliding start position from the abscissa of the sliding end position, as the lateral movement value of the touch point. The touch terminal 110 determines whether the longitudinal movement value of the touch point is greater than the lateral movement value of the touch point, and determines that the sliding operation is the upward sliding operation when it is determined that the longitudinal movement value of the touch point is greater than the lateral movement value of the touch point.

In practical applications, a two-dimensional coordinate system can be established in the graphical user interface in advance, where coordinates of the sliding start position P1 can be represented as (X1, Y1), and coordinates of the sliding end position P2 can be represented as (X2, Y2). In the process of determining, by the touch terminal 110, that the sliding operation is the upward sliding operation based on the relative position between the sliding start position and the sliding end position, the touch terminal 110 obtains a longitudinal movement value (Y2−Y1) of the touch point by obtaining a difference between the ordinate Y2 of the sliding end position and the ordinate Y1 of the sliding start position; obtains a lateral movement value (X2−X1) of the touch point by obtaining a difference between the abscissa X2 of the sliding end position and the abscissa X1 of the sliding start position; and determines that the sliding operation is the upward sliding operation when the touch terminal 110 determines that the longitudinal movement value of the touch point is greater than the lateral movement value of the touch point, i.e., (Y2−Y1)>(X2−X1).

In the technical solution of the implementation, when the movement distance of the touch point is greater than the distance threshold, the longitudinal movement value of the touch point is obtained by obtaining the difference between the ordinate of the sliding end position and the ordinate of the sliding start position, the lateral movement value of the touch point is obtained by obtaining the difference between the abscissa of the sliding end position and the abscissa of the sliding start position, and it is determined whether the longitudinal movement value of the touch point is greater than the lateral movement value of the touch point, which can accurately determine that the sliding operation is the upward sliding operation, and switching the shooting interface to the album interface accurately in response to the user's operation intention.

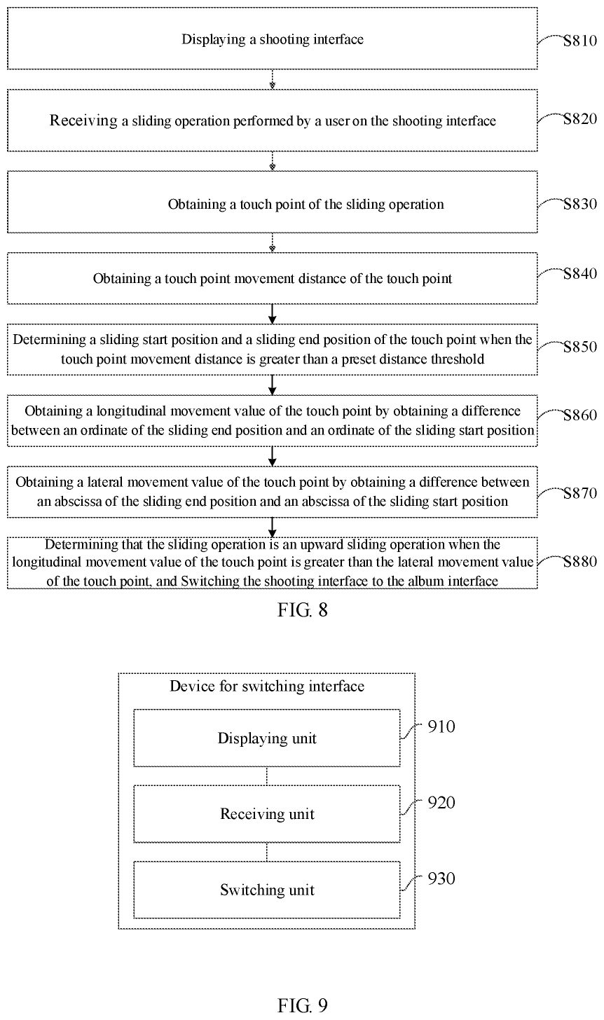

In some implementations, as shown in FIG. 8, a method for switching an interface is provided, and the method specifically includes the following operations. In S810, a shooting interface is displayed. In S820, a sliding operation performed by a user on the shooting interface is received. In S830, a touch point of the sliding operation is obtained. In S840, a touch point movement distance of the touch point is obtained. In S850, a sliding start position and a sliding end position of the touch point are determined in response to that the touch point movement distance is greater than a distance threshold. In S860, a longitudinal movement value of the touch point is obtained by obtaining a difference between an ordinate of the sliding end position and an ordinate of the sliding start position. In S870, a lateral movement value of the touch point is obtained by obtaining a difference between an abscissa of the sliding end position and an abscissa of the sliding start position. In S880, it is determined that the sliding operation is an upward sliding operation in response to that the longitudinal movement value of the touch point is greater than the lateral movement value of the touch point, and the shooting interface is switched to the album interface. For the specific definitions of the above operations, reference can be made to the specific description regarding the method for switching the interface as described above, which will not be repeated here.

In some implementations, a start point of the sliding operation is located in a viewfinder area of the shooting interface, and switching the shooting interface to the album interface in response to that the sliding operation is the predetermined sliding operation includes: obtaining a sliding duration of the sliding operation; and determining that the sliding operation is the predetermined sliding operation in response to that the sliding duration is greater than a time threshold.

The starting point of the sliding operation is located in the viewfinder area of the shooting interface.

The trend of the sliding operation is from the bottom of the shooting interface to the top of the shooting interface.

In some implementations, when the starting point of the sliding operation is in the viewfinder area of the shooting interface and the trend of the sliding operation is from the bottom of the shooting interface to the top of the shooting interface, the process of switching, by the touch terminal 110, the shooting interface to the album interface in response to the sliding operation specifically includes the following operations: obtaining, by the touch terminal 110, a sliding duration of the sliding operation and a time threshold, determining, by the touch terminal 110, whether the sliding duration is greater than the time threshold, and determining, by the touch terminal 110, that the sliding operation is the predetermined sliding operation when the touch terminal 110 detects that the sliding duration is greater than the time threshold, and switching the shooting interface to the album interface. In practical applications, the time threshold can be 0.4 milliseconds.

In the technical solution of the implementation, when the touch terminal receives the sliding operation performed by the user in the viewfinder area of the shooting interface, the user's operation intention can be understand in time by determining whether the duration of the sliding operation is greater than the time threshold, and the shooting interface is switched to the album interface accurately.

In some implementations, the touch terminal is further configured to respond to a gesture control operation performed by the user on the shooting interface, and the method further includes: stopping responding to the gesture control operation performed by the user on the shooting interface when it is determined that the sliding operation is the predetermined sliding operation.

The gesture control operation may refer to an operation of controlling a shooting function of the touch terminal 110 by the user through gesture control, such as sliding to left and right to switch filters, click to focus, two-finger zooming and other gesture operations. In practical applications, when the touch terminal 110 displays the shooting interface, the touch terminal 110 receives and responds to the gesture control operation performed by the user on the shooting interface in real time, and adjusts the shooting function of the touch terminal 110 according to the user's gesture control operation.

In some implementations, in the process of switching the shooting interface to the album interface in response to the sliding operation, when the touch terminal 110 detects that the sliding operation performed by the user on the shooting interface is the predetermined sliding operation, the touch terminal 110 will shield the logic of the touch terminal 110 for detecting and receiving the gesture control operation performed by the user on the shooting interface, and stop responding to the gesture control operation performed by the user on the shooting interface.

According to the technical solution of the implementation, conflict of various touch gestures in the shooting interface can be avoided by stopping responding to the gesture control operation performed by the user on the shooting interface when it is detected that the sliding operation performed by the user on the shooting interface is the predetermined sliding operation, which can reduce the possibility of accidently triggering other control instructions in switching the shooting interface to the album interface in the touch terminal by using the upward sliding gesture by the user.

In some implementations, after the operation of displaying the shooting interface, the method further includes: reading a predetermined number of album images in an album gallery of the touch terminal; generating an album preview image based on the predetermined number of album images; and using the album preview image as an initial frame image of the album interface.

The album gallery may refer to a database storing album images.

The album preview image may refer to a preview image of the album interface.

In some implementations, in response to that the touch terminal 110 displays the shooting interface, the touch terminal 110 reads a predetermined number of album images in the album gallery in advance, and generates the album preview image based on the predetermined number of album images read in advance. Specifically, the touch terminal 110 may read the first N pieces of data, that is, the first N images, in the album gallery in advance, and generate the album preview image based on the first N pieces of data. The touch terminal 110 uses the album preview image as the initial frame image of the album interface. In response to the completion of the slide-up of the album, that is, in response to that the touch terminal 110 switches the shooting interface to the album interface, the touch terminal 110 loads all the image data in the album gallery. In practical applications, N can be 20.

With the technical solution according to the implementation, in response to that the touch terminal displays the shooting interface, the touch terminal pre-loads a predetermined number of album images in the album gallery, and generates the initial frame image of the album interface based on the predetermined number of album images, which can avoid loading too much album data, and thus the touch terminal can quickly switch the shooting interface to the album interface while ensuring the processing performance of the touch terminal in performing shooting tasks.

It should be understood that although the operations in the flowcharts of FIGS. 2, 5 and 8 are sequentially shown in the guidance of arrows, these operations are not necessarily performed sequentially in the order indicated by the arrows. Unless explicitly specified herein, the order of these operations is not strictly limited, and these operations can be performed in other orders. Moreover, at least a part of the operations shown in FIGS. 2, 5 and 8 may include multiple operations or multiple stages which are not necessarily performed simultaneously and may be performed at different times. These operations or stages are not necessarily performed sequentially, and may be performed in turn or alternately with other operations or at least a part of operations or stages of the other operations.

FIG. 9 is a block diagram showing a device for switching an interface according to an example implementation. Referring to FIG. 9, the device includes a display unit 910, a receiving unit 920, and a switching unit 930.

The display unit 910 is configured to display a shooting interface.

The receiving unit 920 is configured to receive a sliding operation performed by a user on the shooting interface.

The switching unit 930 is configured to switch the shooting interface to an album interface in response to that the sliding operation is a predetermined sliding operation.

In some implementations, the switching unit 930 is specifically configured to obtain a touch point of the sliding operation; determine whether the sliding operation is the predetermined sliding operation based on a movement trend of the touch point; and switch the shooting interface to the album interface in response to that the sliding operation is the predetermined sliding operation.

In some implementations, the switching unit 930 is specifically configured to obtain a touch point movement distance of the touch point; determine a sliding start position and a sliding end position of the touch point in response to that the touch point movement distance is greater than a distance threshold; and determine that the sliding operation is the predetermined sliding operation based on a relative position between the sliding start position and the sliding end position.

In some implementations, when the predetermined sliding operation is an upward sliding operation, the switching unit is specifically configured to obtain a longitudinal movement value of the touch point by obtaining a difference between an ordinate of the sliding end position and an ordinate of the sliding start position; obtain a lateral movement value of the touch point by obtaining a difference between an abscissa of the sliding end position and an abscissas of the sliding start position; and determine that the sliding operation is the upward sliding operating in response to that the longitudinal movement value of the touch point is greater than the lateral movement value of the touch point.

In some implementations, a start point of the sliding operation is located in a viewfinder area of the shooting interface, and the switching unit 930 is specifically configured to obtain a sliding duration of the sliding operation; and determine that the sliding operation is the predetermined sliding operation in response to that the sliding duration is greater than a time threshold.

In some implementations, the device further includes: a gesture control response unit configured to respond to a gesture control operation performed by the user on the shooting interface, and a gesture shielding unit configured to stop responding to the gesture control operation performed by the user on the shooting interface by the gesture control response unit in response to that it is determined that the sliding operation is the predetermined sliding operation.

In some implementations, the device further includes: a pre-loading unit configured to read a predetermined number of album images in an album gallery of the touch terminal; a generating unit configured to generate an album preview image based on the predetermined number of album images; and a determining unit configured to use the album preview image as an initial frame image of the album interface.

Regarding the device according to the above implementations, the specific manners in which each of the modules performs operation have been described in detail in the implementations of the relative methods, which will not be repeated here.

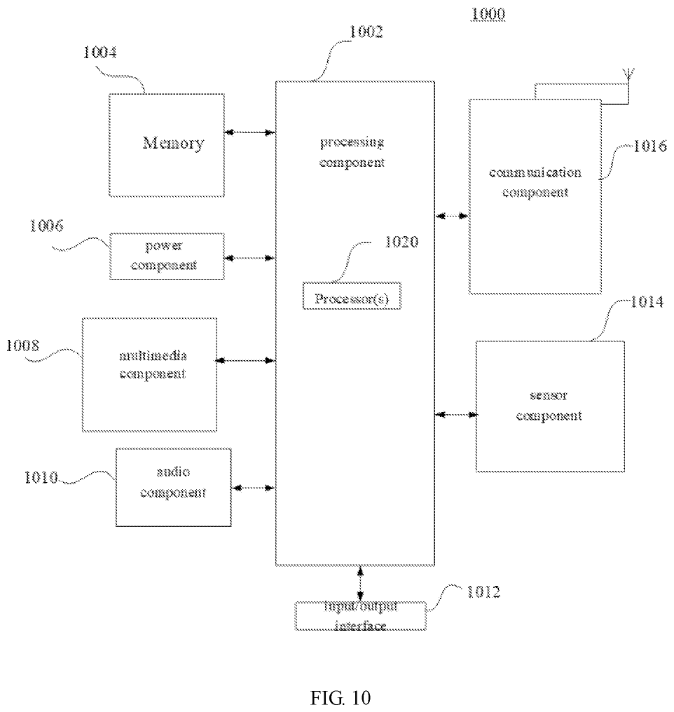

FIG. 10 is a block diagram showing a device 1000 for performing a method for switching an interface according to an example implementation. For example, the device 1000 may be a mobile phone, a computer, a digital broadcasting terminal, a messaging device, a game console, a tablet device, a medical device, a fitness device, a personal digital assistant, etc.

Referring to FIG. 10, the device 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 generally controls the overall operations of the device 100, such as operations associated with display, telephone calls, data communications, camera operations, and recording operations. The processing component 1002 may include one or more processors 1020 to execute instructions so as to implement all or part of the operations of the foregoing method for switching the interface. In addition, the processing component 1002 may include one or more modules to facilitate the interaction between the processing component 1002 and other components. For example, the processing component 1002 may include a multi-media module to facilitate the interaction between the multi-media component 1008 and the processing component 1002.

The memory 1004 is configured to store various types of data to support operations on the device 1000. Examples of the data include instructions for any application or method operating on the device 1000, contact data, phone book data, messages, pictures, videos, etc. The memory 1004 can be implemented in any type of volatile or non-volatile storage device, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk and an optical disk, or a combination thereof.

The power supply component 1006 provides power to various components of the device 1000. The power supply component 1006 may include a power management system, one or more power supplies, and other components associated with generating, managing, and distributing power for the device 1000.

The multi-media component 1008 includes a screen that provides an output interface between the device 1000 and the user. In some implementations, the screen may include a Liquid Crystal Display (LCD) or a Touch Panel (TP). When the screen includes the touch panel, the screen can be implemented as a touch screen for receiving input signals from the user. The touch panel includes one or more touch sensors to sense gestures such as touching and sliding on the touch panel. The touch sensors can not only sense a boundary of the touching or sliding operation, but also detect a duration and pressure associated with the touching or sliding operation. In some implementations, the multi-media component 1008 includes a front camera and/or a rear camera. When the device 1000 is in an operation mode, such as a shooting mode or a video mode, the front camera and/or the rear camera can receive external multi-media data. Each of the front camera and the rear camera can be a fixed optical lens system or have focusing and optical zooming capabilities.

The audio component 1010 is configured to output and/or input audio signals. For example, the audio component 1010 includes a microphone (MIC). When the device 1000 is in an operation mode, such as a call mode, a recording mode or a voice recognition mode, the microphone is configured to receive external audio signals. The received audio signals may be further stored in the memory 1004 or sent via the communication component 1016. In some implementations, the audio component 1010 further includes a speaker for outputting the audio signals.

The I/O interface 1012 provides an interface between the processing component 1002 and a peripheral interface module. The peripheral interface module may be a keyboard, a click wheel, a button, or the like. The button may include but is not limited to a home button, a volume button, a start button, and a lock button.

The sensor component 1014 includes one or more sensors for providing various state evaluations of the device 1000. For example, the sensor component 1014 can detect an on/off state of the device 1000 and relative positioning of a component such as a display or a keypad of the device 1000. The sensor component 1014 can also detect a position change of the device 1000 or a component of the device 1000, presence or absence of contact with the device 1000 by the user, orientation or acceleration/deceleration of the device 1000, and temperature changes of the device 1000. The sensor component 1014 may include a proximity sensor configured to detect presence of a nearby object without any physical contact. The sensor component 1014 may also include an optical sensor, such as a CMOS or CCD image sensor, for use in imaging applications. In some implementations, the sensor component 1014 may also include an acceleration sensor, a gyroscope sensor, a magnetic sensor, a pressure sensor or a temperature sensor.

The communication component 1016 is configured to facilitate wired or wireless communication between the device 1000 and other devices. The device 1000 can access a wireless network based on a communication standard, such as a Wi-Fi, an operator network (e.g., 2G, 3G, 4G, or 5G), or a combination thereof. In an example implementation, the communication component 1016 receives a broadcast signal or broadcast related information from an external broadcast management system via a broadcast channel. In an example implementation, the communication component 616 further includes a Near Field Communication (NFC) module to facilitate short-range communication. For example, the NFC module can be implemented based on a Radio Frequency Identification (RFID) technology, an Infrared Data Association (IrDA) technology, an Ultra-Wideband (UWB) technology, a Bluetooth (BT) technology or other technologies.

In some implementations, the device 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the above methods.

In some implementations, a computer device is provided, including a memory and a processor, and a computer program is stored in the memory. The processor implements all or part of the operations of the above method for switching the interface when the processor executes the computer program.

In some implementations, there is also provided a non-transitory computer-readable storage medium including instructions, such as the memory 1004 including instructions. The instructions can be executed by the processor 1020 of the device 1000 to carry out the foregoing method for switching the interface. For example, the non-transitory computer-readable storage medium may be a ROM, a random access memory (RAM), a CD-ROM, a magnetic tape, a floppy disk, an optical data storage device, etc.

After considering the description and practicing the disclosure disclosed herein, those skilled in the art will easily think of other implementations of the disclosure. The disclosure is intended to cover any variations, uses, or adaptive changes of the disclosure that follow the general principles of the disclosure and include common general knowledge or common technical means in the technical field which are not disclosed in the disclosure. The description and implementations shall be considered example only, and the true scope and spirit of the disclosure are indicated by the claims.

It should be understood that the disclosure is not limited to the precise structures that have been described above and shown in the drawings, and various modifications and changes can be made without departing from the scope thereof. The scope of the disclosure is defined only by the appended claims.

What is claimed is:

1. A method for switching an interface, applied to a touch terminal capable of presenting a graphical user interface, the method comprising:
displaying a shooting interface;
receiving a sliding operation performed by a user on the shooting interface; and
switching the shooting interface to an album interface in response to the sliding operation being a predetermined sliding operation.

2. The method according to claim 1, wherein said switching the shooting interface to the album interface comprises:
obtaining a touch point of the sliding operation;
determining whether the sliding operation is the predetermined sliding operation based on a movement trend of the touch point; and
switching the shooting interface to the album interface in response to the sliding operation being the predetermined sliding operation.

3. The method according to claim 2, wherein said determining whether the sliding operation is the predetermined sliding operation comprises:
obtaining a touch point movement distance of the touch point;
determining a sliding start position and a sliding end position of the touch point in response to the touch point movement distance being greater than a distance threshold; and
determining that the sliding operation is the predetermined sliding operation based on a relative position between the sliding start position and the sliding end position.

4. The method according to claim 3, in response to the predetermined sliding operation being an upward sliding operation, said determining that the sliding operation is the predetermined sliding operation comprises:
obtaining a longitudinal movement value of the touch point by obtaining a difference between an ordinate of the sliding end position and an ordinate of the sliding start position;
obtaining a lateral movement value of the touch point by obtaining a difference between an abscissa of the sliding end position and an abscissa of the sliding start position; and
determining that the sliding operation is the upward sliding operation in response to the longitudinal movement value of the touch point being greater than the lateral movement value of the touch point.

5. The method according to claim 1, in response to a starting point of the sliding operation being located in a viewfinder area of the shooting interface, said switching the shooting interface to the album interface comprises:
obtaining a sliding duration of the sliding operation; and
determining that the sliding operation is the predetermined sliding operation in response to the sliding duration being greater than a time threshold.

6. The method according to claim 1, wherein the touch terminal is further configured to respond to a gesture control operation performed by the user on the shooting interface, and the method further comprises:
stopping responding to the gesture control operation performed by the user on the shooting interface in response to the sliding operation being the predetermined sliding operation.

7. The method according to claim 1, further comprising:
reading a predetermined number of album images in an album gallery of the touch terminal;
generating an album preview image based on the predetermined number of album images; and
determining an initial frame image of the album interface based on the album preview image.

8. A touch terminal capable of presenting a graphical user interface, comprising:
one or more processors; and
a memory for storing instructions executable by the processor,
wherein, the one or more processors are configured to execute the instructions to perform operations comprising:
displaying a shooting interface;
receiving a sliding operation performed by a user on the shooting interface; and
switching the shooting interface to an album interface in response to the sliding operation being a predetermined sliding operation.

9. The touch terminal according to claim 8, wherein said switching the shooting interface to the album interface comprises:
obtaining a touch point of the sliding operation;
determining whether the sliding operation is the predetermined sliding operation based on a movement trend of the touch point; and
switching the shooting interface to the album interface in response to the sliding operation being the predetermined sliding operation.

10. The touch terminal according to claim 9, wherein said determining whether the sliding operation is the predetermined sliding operation comprises:
obtaining a touch point movement distance of the touch point;
determining a sliding start position and a sliding end position of the touch point in response to the touch point movement distance being greater than a distance threshold; and
determining that the sliding operation is the predetermined sliding operation based on a relative position between the sliding start position and the sliding end position.

11. The touch terminal according to claim 10, in response to the predetermined sliding operation being an upward sliding operation, said determining that the sliding operation is the predetermined sliding operation comprises:
obtaining a longitudinal movement value of the touch point by obtaining a difference between an ordinate of the sliding end position and an ordinate of the sliding start position;
obtaining a lateral movement value of the touch point by obtaining a difference between an abscissa of the sliding end position and an abscissa of the sliding start position; and
determining that the sliding operation is the upward sliding operation in response to the longitudinal movement value of the touch point being greater than the lateral movement value of the touch point.

12. The touch terminal according to claim 8, in response to a starting point of the sliding operation is located in a viewfinder area of the shooting interface, said switching the shooting interface to the album interface comprises:
obtaining a sliding duration of the sliding operation; and
determining that the sliding operation is the predetermined sliding operation in response to the sliding duration being greater than a time threshold.

13. The touch terminal according to claim 8, wherein the touch terminal is further configured to respond to a gesture control operation performed by the user on the shooting interface, and said operations further comprises:
stopping responding to the gesture control operation performed by the user on the shooting interface in response to the sliding operation being the predetermined sliding operation.

14. The touch terminal according to claim 8, wherein said operations further comprises:
reading a predetermined number of album images in an album gallery of the touch terminal;
generating an album preview image based on the predetermined number of album images; and
determining an initial frame image of the album interface based on the album preview image.

15. A non-transitory computer-readable storage medium storing thereon instructions, when being executed by one or more processors of a touch terminal capable of presenting a graphical user interface, cause the touch terminal to perform operations comprising:
displaying a shooting interface;
receiving a sliding operation performed by a user on the shooting interface; and
switching the shooting interface to an album interface in response to the sliding operation being a predetermined sliding operation.

16. The storage medium according to claim 15, wherein said switching the shooting interface to the album interface comprises:
obtaining a touch point of the sliding operation;
determining whether the sliding operation is the predetermined sliding operation based on a movement trend of the touch point; and
switching the shooting interface to the album interface in response to the sliding operation being the predetermined sliding operation.

17. The storage medium according to claim 16, wherein said determining whether the sliding operation is the predetermined sliding operation comprises:
obtaining a touch point movement distance of the touch point;
determining a sliding start position and a sliding end position of the touch point in response to the touch point movement distance being greater than a distance threshold; and
determining that the sliding operation is the predetermined sliding operation based on a relative position between the sliding start position and the sliding end position.

18. The storage medium according to claim 17, in response to the predetermined sliding operation being an upward sliding operation, said determining that the sliding operation is the predetermined sliding operation comprises:
obtaining a longitudinal movement value of the touch point by obtaining a difference between an ordinate of the sliding end position and an ordinate of the sliding start position;
obtaining a lateral movement value of the touch point by obtaining a difference between an abscissa of the sliding end position and an abscissa of the sliding start position; and
determining that the sliding operation is the upward sliding operation in response to the longitudinal movement value of the touch point being greater than the lateral movement value of the touch point.

19. The storage medium according to claim 15, in response to a starting point of the sliding operation being located in a viewfinder area of the shooting interface, said switching the shooting interface to the album interface comprises:
obtaining a sliding duration of the sliding operation; and
determining that the sliding operation is the predetermined sliding operation in response to the sliding duration being greater than a time threshold.

20. The storage medium according to claim 15, wherein the touch terminal is further configured to respond to a gesture control operation performed by the user on the shooting interface, and the operations further comprises:
stopping responding to the gesture control operation performed by the user on the shooting interface in response to the sliding operation being the predetermined sliding operation.
